(19) United States
(12) Patent Application Publication
(10) Pub. No.: US 2006/0015408 A1
(43) Pub. Date: Jan. 19, 2006

(54) System and method employing radio frequency identification in merchandising management

(76) Inventor: Robert G. Brown, Dobbs Ferry, NJ (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/057,890

(22) Filed: Feb. 14, 2005

Related U.S. Application Data
(60) Provisional application No. 60/543,548, filed on Feb. 12, 2004.

(51) Int. Cl. G06G 1/14; G06Q 20/00

(52) U.S. Cl. 705/22

(57) ABSTRACT

A method for obtaining information about the location of an object or individual bearing an RFID tag. Able to monitor movements of the object or person bearing the tag, a merchandising service provider is able to determine the effectiveness of displays and promotions, evaluate plan-o-gram compliance, verify the location of fixtures, and monitor the movements of servicing personnel at a retail location. The merchandising service provider can further integrate and analyze the information obtained from the RFID tags substantially in real time.

### CROSS-REFERENCE TO RELATED APPLICATIONS

This Patent Application is based upon and claims the benefit of U.S. Provisional Application No. 60/543,548, filed Feb. 12, 2004, entitled “System And Method Employing Radio Frequency Identification In Merchandising Management,” the entirety of which is incorporated herein by reference.

### FIELD OF THE INVENTION

The present invention relates to systems and methods for electronically managing retail merchandising and training activities, and in particular to a system and method that employs Radio Frequency Identification (RFID) technology to carry out item-level merchandising and training.

### BACKGROUND OF THE INVENTION

In recent years, competitive pressures have imposed increasingly complex merchandising-related choices on manufacturers and retailers. To be as effective and cost-efficient as possible, merchandising needs to make the right products available to the consumer at the right time. Further, manufacturers and retailers have come to recognize the increasing importance of the proper training of their sales associates on a product level. Faced with an increasing number of brands, shorter product cycles, geographically disparate product distribution, and competition from the Internet, manufacturers and retailers operate in an environment where the marginal effect of choices related to merchandising—that is, how products come to be presented to the consumer—can be critical.

The technology that has been employed to carry out such merchandising and training has not kept pace with the increased competition in the market. Fortunately, recent developments in technology have proven effective in assisting in both merchandising and training efforts.

For example, conventional bar coding has been applied in supply chain, inventory and sales management. However, the specific technology of bar coding suffers from several limitations that can be improved by the present invention.

First, bar coding can be labor-intensive and thus costly relative to net sales. Further, the technology used in obtaining accurate integrated product information in real-time based on bar-coded products can be inadequate.

Additionally, conventional bar coding practices require that the bar code reader is in close physical proximity to the bar code. However, there may be a limited number of readers available, limited labor resources, and a relatively large amount of products with bar codes over a relatively large physical area, posing significant efficiency problems. As scale increases, and with it the need for integrated real-time analysis of product information, the benefits of bar coding diminish correspondingly.

An added limitation to electronically capturing product information is the human factor. Personnel charged with reporting on product information may convey inaccurate numbers. For example, an individual, such as a retail clerk or other person, may acquire product information and then convey that information to a central location. However, the numbers conveyed may be inaccurate. The problem is particularly acute where the method of obtaining product information is by pen and paper.

Nonetheless, whether data is collected by bar coding, pen and paper, or a combination of both, the following example illustrates the limitations therein. For instance, an individual collecting product information at the direction of a retailer or other entity may collect such results in a spreadsheet. The spreadsheet may contain errors, unintentional or otherwise, which taint additional numbers the source of which is the original inaccurate data. In short, the retailer or other entity cannot rely on the figures. It is desirable to have a system where the retailer or other entity does not have to rely on a unneeded reporting layer between data collection and transmission, leading to more accuracy, real-time results and confidence in the data collected and analysis thereof.

It is desirable to have a technology based merchandising system and method that increases efficiency and maximizes sales revenues. It is further desirable to have a technology that provides data as granular as possible, i.e., to effectively track products at the item-level. At the same time, it is desirable to integrate the overwhelming amount of data generated by item-level tracking into an understandable synthesis that conveys valuable information to the manufacturer, retailer, or other interested party.

It is further desirable to apply technology to the training and the tracking of training of retail sales personnel.

### SUMMARY OF THE INVENTION

The present invention solves the technical problems of the bar code technology of the prior art as it relates to merchandising and product training through the use of RFID technology. Using RFID technology, a merchandising service provider is able to track specific products and more importantly, track the location and sales of individual products. The system of the present invention is thus able to specifically track the location of where a particular product was picked up by a customer in a store prior to purchase. This feature is especially advantageous in determining the effectiveness of promotional displays, end cap displays and/or checkout displays.

RFID technology is further used in the present invention to verify compliance with client supplied plan-o-grams. As known to those skilled in the art, a plan-o-gram is the physical placement of products in a retail location, specifically, the physical locations on store shelves. In a preferred embodiment, a shelf known as a smart shelf is used that incorporates an RFID reader directly into the shelf. The smart shelf is thus able to immediately scan all RFID tagged products placed on the shelf and an immediate comparison to the plan-o-gram can be executed. All of the data from the smart shelf or other RFID readers at the retail location can be transmitted in real time back to the merchandising service provider and made immediately available to the client.

RFID technology is further used in the present invention to tag and track promotional fixtures themselves, wherein one can keep track of how many fixtures are out in the field and where they are located.

RFID technology is further used in the present invention to track and monitor service visits to retail locations by merchandising servicers. The servicer is issued a badge that contains an RFID tag that is read as the servicer enters and leaves the various retail locations. The merchandising service provider (and in turn the client) can accordingly track the stores that the servicer has visited, as well as keep track of the time the servicer spent in a particular location.

Further, RFID tags can be used to track the attendance of individuals at events such as product demonstrations, or demonstrations of the use of RFID tags themselves. Specifically, the attendance of retail sales personnel at a product training exercise can be tracked and reported back to the retailer or manufacturer.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 is a block diagram of the basic components in RFID technology;

FIG. 2 is a schematic diagram of the use of RFID technology in a retail environment by a merchandising service provider; and

FIG. 3 illustrates the end to end data flow of RFID collected data from a retail location to a client.

FIG. 4 illustrates the process flow for auditing and tracking service visits to remote retail locations.

FIG. 5 is an exemplary main menu of the user interface of the system of the present invention.

FIG. 6 illustrates the system of the present invention detecting and uploading RFID tag information.

FIG. 7 illustrates an exemplary screen showing a stop audit message.

FIG. 8 illustrates an exemplary user interface screen of the system of the present invention showing the option of uploading audit data.

FIG. 9 illustrates the creation of an audit record by the system of the present invention.

FIG. 10 illustrates an exemplary screen showing a message suggesting that the user upload files yet to be transferred.

FIG. 11 is a flowchart illustrating the process of tracking product demonstration using the RFID tag technology of the present invention.

FIG. 12 illustrates an exemplary user interface screen of the system of the present invention for inputting particular job details into the system.

FIG. 13 illustrates an exemplary user interface screen of the system of the present invention displaying the demonstrations available in the system.

FIG. 14 illustrates an exemplary user interface screen of the system of the present invention showing a manner of carrying out a demonstration.

FIG. 15 illustrates an exemplary user interface screen of the system of the present invention confirming audience details and RFID tags associated with carrying out a demo.

FIG. 16 illustrates an exemplary user interface screen of the system of the present invention depicting a report generated associated with carrying out a demo.

### DETAILED DESCRIPTION OF EMBODIMENTS OF THE INVENTION

RFID broadly describes technologies that use radio-frequency waves to identify individual items. Typically, RFID tags that transmit radio waves are affixed to the items. The radio waves thus emitted are detected (read) by RFID readers. The fundamentals of RFID technology are well-known to those of skill in the art, and the present application focuses on aspects of RFID that contribute to an understanding of the present invention.

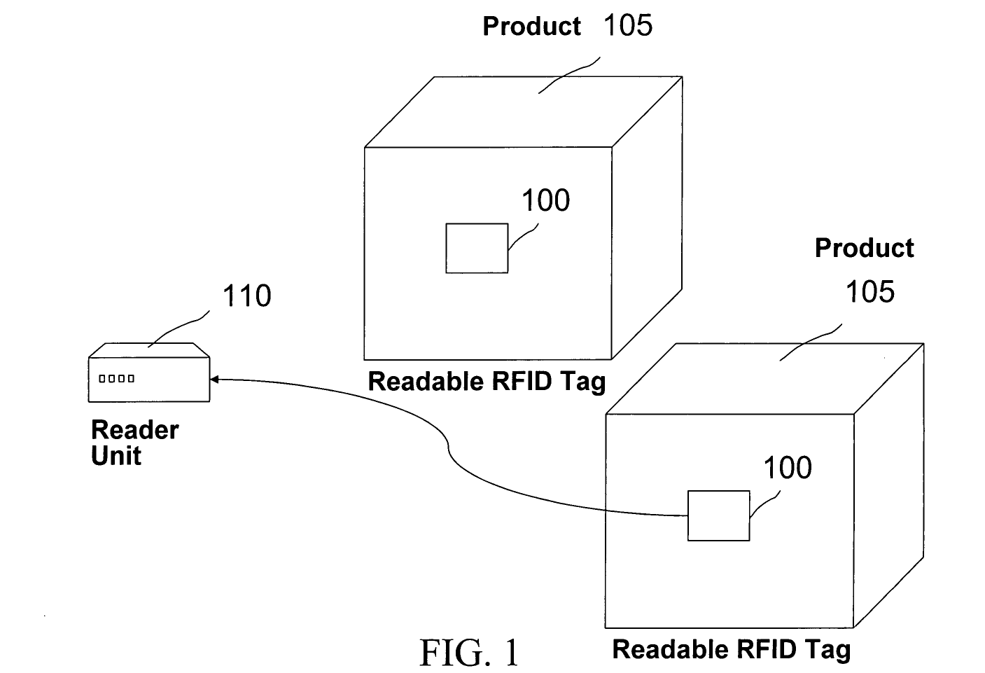

FIG. 1 shows the main components in the retail use of RFID technology. To track individual products 105, a readable RFID tag 100 is used. The tag 100 can be either active or passive. In an active tag 100, the tag 100 typically has a power source, a microchip and an antenna (which may be coiled). The tag 100 actively transmits information contained on the tag 100 such as unique product identifier information. In a passive tag 100, a signal from a reader 110 activates the tag 100 which then transmits the identification information. In both the active and passive tags 100, the tag 100 is placed on a product 105 to be tracked. The unique product identifier information can include information such as serial number, point in the supply chain, and the like. The RFID reader 110 receives and stores the information contained in and transmitted by the RFID tag 100.

Presently, a typical RFID tag 100 can carry up to 2 KB of information. Generally, each tag 100 has at least product ID. Beyond this, it is possible to embed a substantial amount of other useful information on a tag 100, including price, lot number, manufacture date, promotional code, and display type. The products 105 may be tagged by the merchandising service provider or by another party such as the manufacturer itself. A “merchandising service provider” is an entity that provides the merchandising management services described herein for manufacturers, chain retailers or individual stores, for example. The merchandising service provider is preferably a single point of access, making it convenient for the retailer, manufacturer or other party making use of its services. Tags 100 can be programmed at a central location by the merchandising service provider and then shipped to the field for placement of the tag 100 on each product 105.

As described above, RFID tags 100 can be passive or active. A passive RFID tag 100 is powered by a magnetic field emitted by the reader 105. The passive RFID tag 100 draws power from the magnetic field to generate a current in the antenna. Power is thus supplied to the tag's microchip. The microchip then modulates a return transmission to the reader 110. An active RFID tag 100 contains a power source within the tag itself, and is usually more costly than the passive RFID tag 100. Semi-passive tags 100 use both a self-contained power source and draw power from the reader 110.

RFID is well-suited for real-time reporting as products 105 move from point of purchase to point of sale as the combination of the tag 100 and the reader 110 is able to report the product identification information encoded on the tag 100 as well as the location of the product 105.

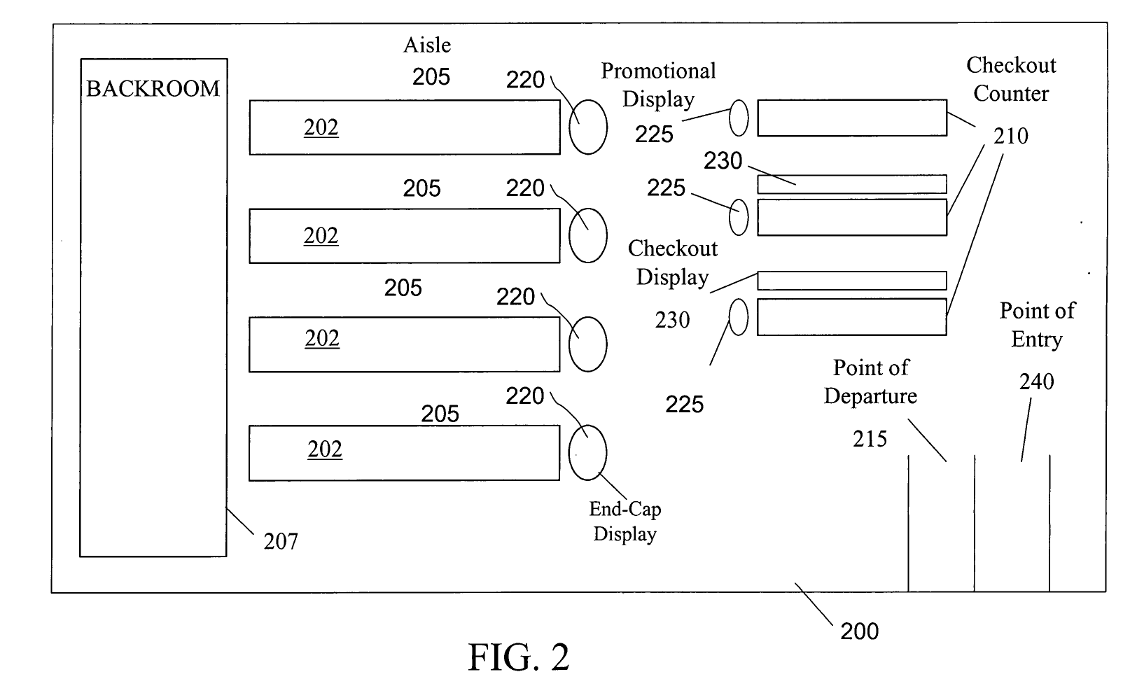

FIG. 2 depicts the deployment of the RFID technology throughout the facility of a specific retail location 200. As illustrated in FIG. 2, RFID readers 110 may be located in multiple locations in store 200 with respect to the tagged items. RFID readers may be located closely adjacent to the items as displayed to the consumer, for example on the shelves 202 in the aisles 205. Additional RFID readers may be located at the point of sale, for example a checkout counter 210. RFID readers may be located at various locations on the ceiling of the retailer's public space, or in the retailer's backroom 207, storeroom or warehouse. RFID readers may be installed at each point of departure (i.e., exit) 215 and scan products that leave the store (the assumption being that the product was purchased). RFID readers may be located at promotional displays 225. RFID readers may similarly be located at end cap displays 220 or check out displays 230. RFID readers may also be located at a point of entry (i.e., entrance) 240.

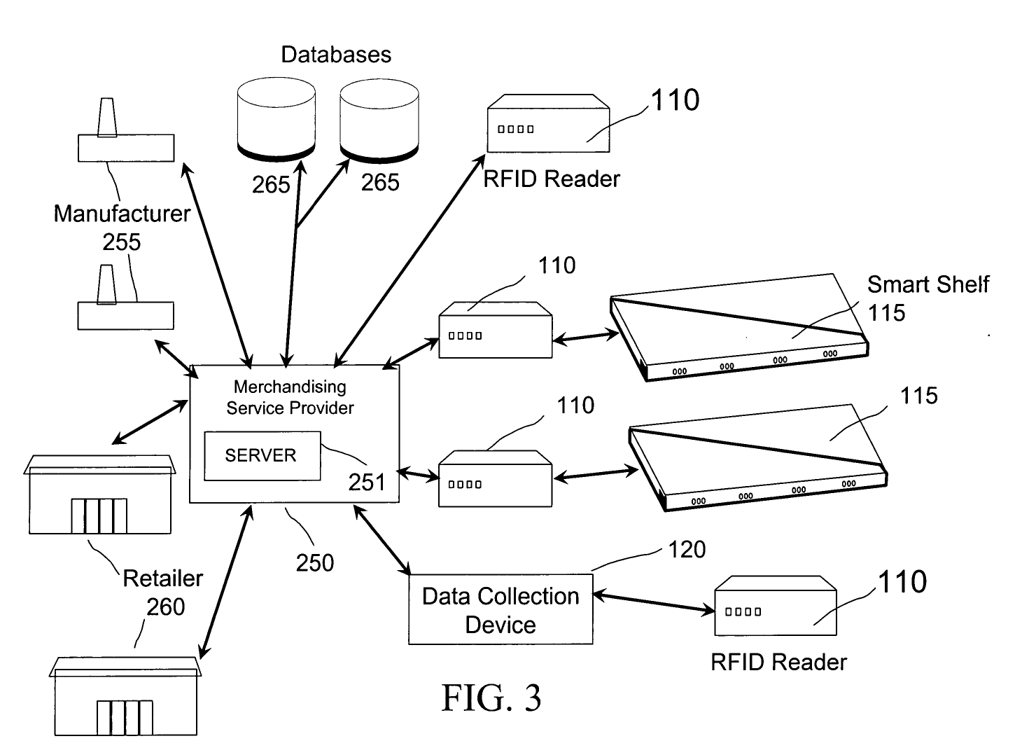

As illustrated in FIG. 3, any or all of the RFID readers 100 can report tag information, such as product ID and product location, to a merchandising service provider 250. As further described below, one of skill in the art will understand that the merchandising service provider 250 can employ multiple ways to receive, process and transmit, data, including by means of a centralized server 251, distributed computing, or otherwise. Further, merchandising service provider 250 can store any desired information in one or more databases 265.

The reporting of tag identification information can take place by means of a data link, such as the Internet, a wireless network, or a dedicated link. The data is transmitted to the merchandising service provider 250 preferably by secure and dynamic web-based services such as XML. After obtaining the data, the merchandising service provider 250 can process the data and distribute information to retailers 260 or manufacturers 255. As seen in FIG. 3, in one embodiment, a data collection device 120 such as a laptop, PDA or PC can be used to collect RFID tag information from the RFID readers 110. The data collection device 120 can then be used to transmit (upload) the data to the centralized server 251 at the merchandising service provider 250. Alternatively, the RFID readers 100 themselves can include transmission capabilities such that they can independently upload RFID tag information to the centralized server 251.

The merchandising service provider 250 manages the RFID generated product information transfer. Merchandising service provider 250 has data links with the retailers 260 and manufacturers 255. It will be readily appreciated that there may be a plurality of retailers 260, as well as a plurality of manufacturers 255. It will also be appreciated that the retailer 260 may be the client for the merchandising service provider's services, the manufacturer 255 may be the client, or both may be the client.

One aspect of the present invention is to measure the effectiveness of product displays such as illustrated in the end cap 220, promotional display 225 or checkout display 230 as illustrated in FIG. 2. Products may be located in a display environment to make them appealing to consumers and give consumers quick knowledge about a product's features. The display 220, 225, 230 may be developed by the retailer or manufacturer or both. The display 220, 225, 230 may be part of a special promotion, or it may be maintained in the day-to-day retail environment. A client may wish to measure the effectiveness of a given display 220, 225, 230, based on information obtained by RFID and sent to the merchandising service provider 250 for analysis and processing. In addition, the variable to be measured may be product packaging, wherein the merchandising service provider 250 can compare sales from the same store 200 based on variably packaging the same product, or compare sales from different stores on the same basis.

For example, the display 220, 225, 230 may embrace a promotion of DVDs (Digital Video Disks). The display 220, 225, 230 may comprise, for example, an aisle 205 within the retailer's store 200 in which is located a fixture on which DVDs are propped. RFID tags 100 are included on each DVD. There are many examples of how the merchandising service provider 250 can obtain and distribute useful integrated information related to displays or promotions 220, 225, 230. The merchandising service provider 250 can track continuous, real-time reporting of immediate, store-specific data. Further, the merchandising service provider 250 can deliver real-time, online graphic reporting of project status to the retailer 260 or manufacturer 255. Sales of individual titles of DVDs can be specifically identified and buying trends obtained. For instance, the merchandising service provider 250 can compare the sales of a given DVD when located within a special display 220, 225, 230 compared to when the special display 220, 225, 230 is not used. Also, it can be immediately perceived when a given display 220, 225, 230 or portion thereof is “sold out” and thus needs to be restocked.

In order to track the effectiveness of a display 220, 225, 230, the RFID tags 100 on the products on the display can be programmed to indicate the location of the product on the display 220, 225, 230. When the RFID reader 110 scans the purchase of the product, the merchandising service provider 250 can immediately determine that this product was taken from the display 220, 225, 230 (as opposed to being picked up from a shelf). Alternatively, an RFID reader 110 can be installed directly on the display fixture 220, 225, 230 and can read when a product is being picked up from the display 220, 225, 230. In another alternative, a central database 265 (at the merchandising service provider or the retailer) can keep track of the location of uniquely RFID tagged products as the products are placed on the displays 220, 225, 230 (or shelves 202). As the product is scanned at the time of purchase, the record for the purchase transaction can be uploaded and linked to the location record in database 265 and the merchandising service provider 250 can determine the exact location from which a particular purchased product was sold.

Further, the client (retailer 260 or manufacturer 255, for example) can monitor store-by-store progress of display installation in real-time. Knowledge of exactly when and where displays 220, 225, 230 are installed is thus available, maximizing the effectiveness of supporting advertising.

It is also possible to use a “smart shelf” 115 that uses RFID technology as illustrated in FIG. 3. A smart shelf 115 is a retailer shelf that is RFID reader equipped, and reads the products on the shelf. Smart shelves are useful in gathering real-time inventory data. To minimize the number of RFID readers 110 needed, smart shelves 115 may be interconnected such that multiple shelves 115 may require only one external reader unit or a minimum of readers. For instance, four shelves 115 arranged vertically one on top of the other may be linked in a “daisy chain.” The lowest shelf 115 communicates electronically with the shelf 115 above it, which communicates electronically with the shelf 115 above it, which communicates electronically with the highest shelf 115. The highest shelf 115, which contains the information sent from the lower shelves 115, is then read by the external reader unit 110. This permits multiple shelves 115 to use only one external reader. Obviously, this is one configuration of smart shelves 115, and other configurations may be just as useful and desirable. Of course, as described elsewhere, an RFID reader 110 does not need to be connected with a smart shelf 115, and can be used independently of a smart shelf 115.

In addition, the effect of store layout on consumer behavior can be measured. For example, it can be determined whether a display 220, 225, 230 is more effective or less effective when located near other types of products. Or, it can be determined whether a display 220, 225, 230 is more effective or less effective when near a checkout counter 210.

Another aspect of the current invention is to monitor plan-o-gram compliance, preferably in conjunction with a smart shelf 115. A plan-o-gram is a schematic or drawing of product placement for a given fixture (e.g. shelf) for a given retail location. Manufacturers 255, retailers 260 and brand managers may have specific plan-o-grams in mind for optimizing product sales.

Out in the field, however, the plan-o-gram may not be uniformly implemented or even implemented at all for a variety of reasons. The current invention helps to ensure plan-o-gram compliance by use of RFID technology. For example, the client (retailer 260 or manufacturer 255, for example) can communicate plan-o-gram requirements to the merchandising service provider 250 and set a plan-o-gram compliance threshold. Using the RFID tags 100 on the products and the smart shelves 115, the merchandising service provider 250 can immediately determine if the product placement on the shelves 115 is in accordance with the plan-o-gram supplied by the manufacturer 255 or retailer 260. In an alternative to the smart shelf 115 technology, a handheld RFID reader 110 can be used to scan and identify the products placed on particular shelves in particular locations.

The smart shelf 115 can also facilitate product resets. Resets occur when the product assortment, placement and/or configurations are changed. Similar to the plan-o-gram compliance arrangement described above, smart shelves 115 can be used to ensure proper product resets. The smart shelf 115 will help to ensure that the old assortment and/or configurations are changed and the new one adopted.

Similarly, smart shelves 115 or handheld RFID scanners 110 can facilitate product recalls. If a manufacturer 255 undertakes a product recall, the progress and effectiveness thereof can be monitored in order to restock with a substitute product or confirm that the product is off the shelves.

Inventory control is an additional application of the technology of the present invention. Based on RFID-derived data, the merchandising service provider 250 can inform the client (retailer 260 or manufacturer 255, for example) when an item is out of stock. Also, actual inventory can be compared with expected inventory, indicating that the differential is due to product theft. Further, inventory can be reduced selectively, enabling reallocation of capital.

In another aspect of the invention, RFID technology can be used to track the promotional fixtures (displays) themselves, in addition to or instead of tracking the individual items on the fixtures. A method of the present invention can thus enable the client (retailer 260 or manufacturer 255, for example) to keep track of how many fixtures are out in the field and where they are located. The fixtures may be associated with a special promotion, or be an everyday fixture.

In another aspect of the invention, the technology can be used to track and manage servicing personnel. Servicing personnel can be agents of the client (retailer 260 or manufacturer 255, for example) sent to the field to perform merchandising activities. The servicing personnel could alternatively be service brokers, registered with the merchandising service provider 250 by the client. Further, the service broker can register vendors who work for them. Collectively, the above are referred to as “servicing personnel.” Servicing personnel are issued an identification device containing an RFID tag comparable to an RFID tag 100 that is placed on a product 105.

When servicing personnel visit a retailer 260, they must “sign in” and “sign out” through the identification system (i.e., an RFID reader 110 in the retailer's location 200). Similarly, when a servicing person exits the store, the RFID reader 110 records the time the person left the facility. As a result, the merchandising service provider 250 can first provide an affirmative report to the clients that the service person actually visited the store 200 and the time that was spent in the store. As many of the clients are charged for the service of the servicing personnel on an hourly basis, the time in and time out of a store 200 by a service person can be accurately monitored and tracked. The merchandising service provider 250 and the client thus have real time access to data that can be used to hold the servicing personnel accountable. The client can validate work performed compared to work contracted for. For example, the client can learn whether the servicing personnel are performing the job in a timely manner and completed a job. Furthermore, the link from the retailer's store location to the merchandising service provider 250 (e.g., though data collection device 120, FIG. 3) can be used by the servicing personnel to transmit its reports in real time to the merchandising service provider 250 which in turn can make the reports available to the retailer 260 or manufacturer 255.

Thus, it can be appreciated that the present invention enables auditing service personnel who are visiting a store 200 to perform work. It can also keep track of total time of those persons who carry authorized RFID tags. The RFID technology of the present invention can detect and collect time-in and time-out information in a store and upload that information to the centralized server 251 and database 265. Therefore, it might be thought of as enabling local or remote service auditing and/or labor management, where one is able to determine, for numerous stores, what services have been performed, when and by whom, among other things. This permits enhanced controls over payment for work, enables analysis of average time to complete assignments, enables real-time reports to clients to provide assurances of contracted work, and permits logistical control improvements in the field.

As previously described, as seen in FIG. 3, a data collection device 120 such as a laptop, PDA, handheld device or PC can be placed between the RFID reader 110 and the merchandising service provider 250. The data collection device 120 can be portable or permanently installed. This aspect of the invention enables providing real-time job assignment updates, store-specific tracking and resolution data.

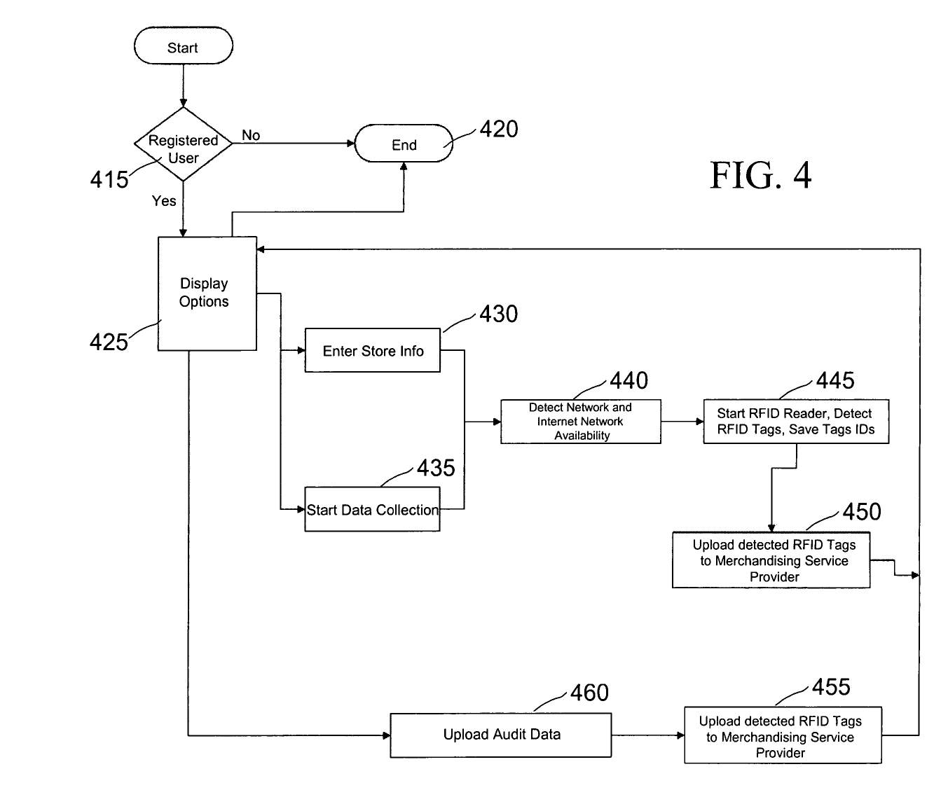

FIG. 4 illustrates service audit features in accord with one aspect of the present invention. This functionality can be implemented by means of a processor or processors running the service audit application. It can be appreciated that the processor(s) can be located in data collection device 120, at the central server 251 at the merchandising service provider 250, in both, or elsewhere. Initially, one attempts to gain access to the system by qualifying as a registered user 415, for example through a password protected sign-in process. If the user is not registered, the process ends 420 because access is unauthorized. If the user is registered, options are displayed 425.

The system enables one to optionally enter store information 430, such as a unique store ID. Alternatively, the user can begin data collection 435. If either option is chosen, network and Internet availability is detected 440. Once network and Internet availability is established, the system can start an RFID reader 100, detect RFID tags 100 and save tag IDs 445. Further, detected RFID tags can be uploaded from a remote location (e.g., from a reader 100 or data collection device 120 at a retailer's store 200) to the central server 251 and databases 265 at the merchandising service provider 250. At this point, it is possible to have the options again displayed 425. Additionally, after the options are displayed, one may upload audit data 460, as further described below, thus uploading the information contained on the RFID tags to the merchandising service provider 250.

In one aspect of the invention, the RFID functionality is event-driven where each event is communicated via data transmission to the merchandising service provider 250. The data can contain information on a unique RFID badge i.d. (i.e., the RFID tag can be included in an employee badge and/or generic asset tag), reader i.d., and time.

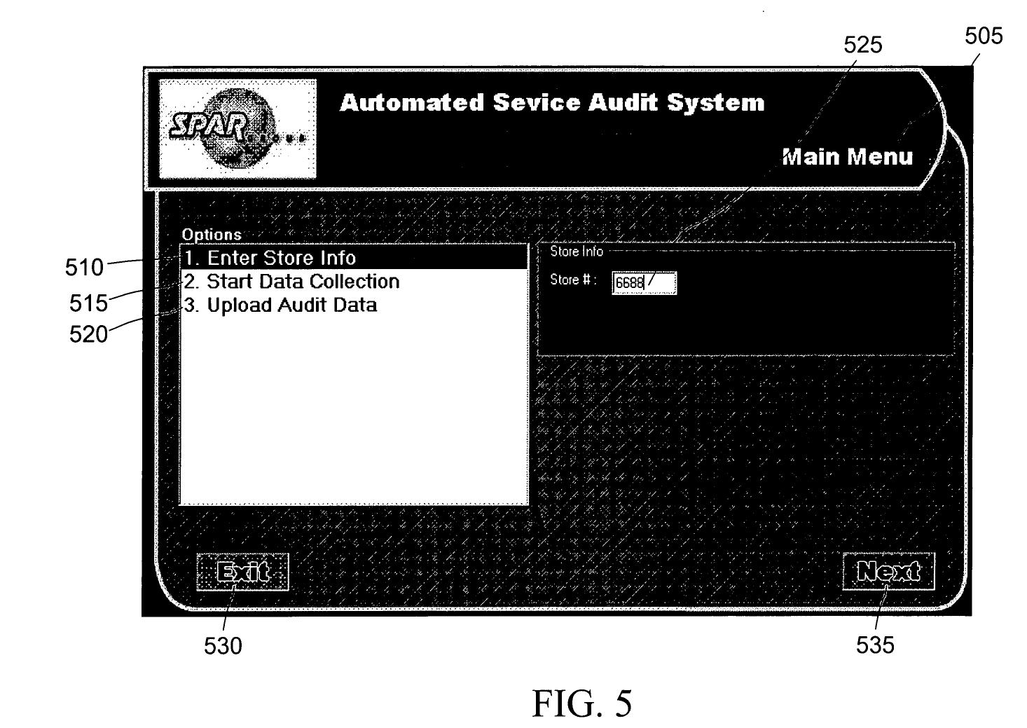

In FIG. 5, an exemplary user interface screen of the system of the present invention illustrating a main menu 505 is shown. The user is presented with options including entering store information 510. Store information can include the store number 525. Here, the store number 525 entered by the user identifies a unique store.

Alternatively, the user can start data collection 515 or upload audit data 520. Further, the user may, of course, exit 530 from the application. Once the desired information is selected, the user can click next 535. As can be appreciated, the graphical user interface (GUI) that can be used with the application can take many appearances and have diverse functionality. An exemplary GUI only is shown herein by way of non-limiting example.

Upon execution of the user's instructions, the system first detects whether or not there is connectivity between the central server 251 and the remote device (e.g., data collection device 120). If an Internet or other communications link is not detected, the user is prompted whether to continue the application.

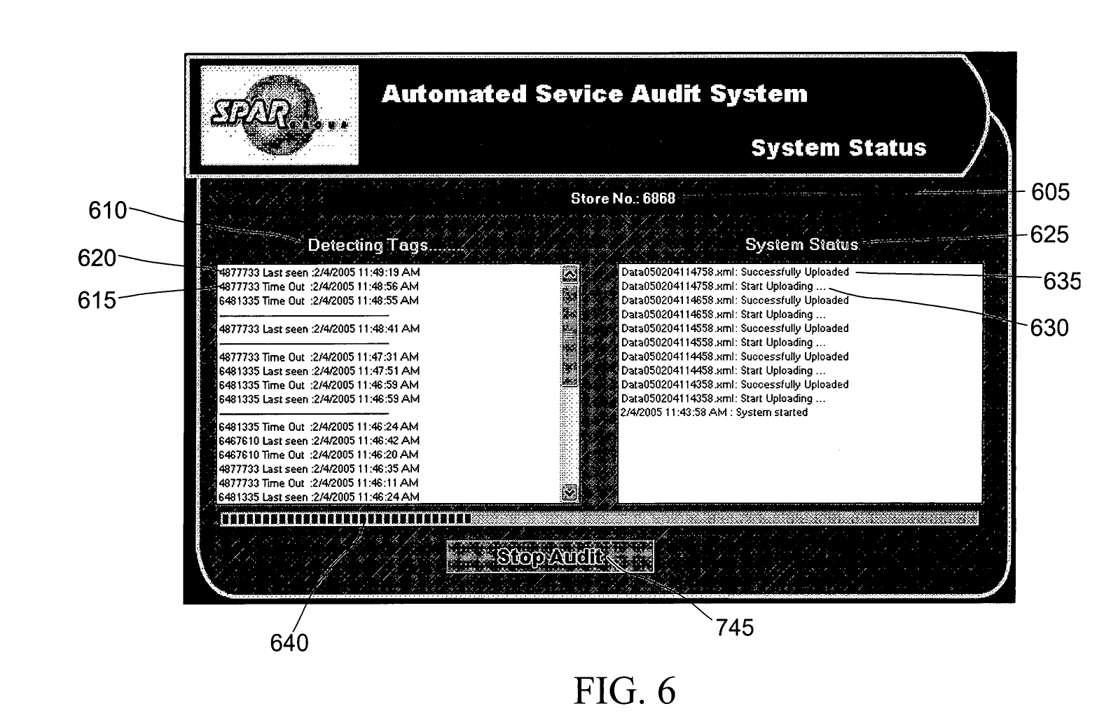

FIG. 6 shows an exemplary user interface screen of the system of the present invention illustrating showing the detection and uploading of service personnel RFID tag information. The RFID tag information is associated with a given store number 605. As seen in area 610 of the user interface, the system enables the detecting tags 6 as the service personnel enter and leave the store. Specific entries for such tag detection may be seen in items 615 and 620. Entry 615 indicates that RFID tag number 487733 came into range on Feb. 4, 2005 at 11:48:41 a.m. Entry 620, on the other hand, indicates that tag 487733 went out of range on Feb. 4, 2005 at 11:48:56 a.m. It is assumed that the first time that a tag is detected on a given day that the tag is now “in range.”

The detection of a service person's RFID tag may be passive or active. By passive, it is meant the readers 110 can detect the service person's presence as soon as he/she enters the store location. Alternatively, the system can be designed in an active mode, where the service person must actively use his/her RFID tag to record his/her presence at the store location (i.e., to effectively “sign in”). As can be appreciated, the application of the technology of the present invention greatly enhances the reliability and auditing capabilities of the tracking of service personnel. As the RFID tag on the badge of the service person must be physically present at the store location in order to be recorded, the retailer 260 or manufacturer 255 can be assured that that the service person actually visited the store at the times indicated in the auditing reports.

Returning to FIG. 6, the system provides the user with a status report 625. For example, if the system starts uploading audit data 630 as further described below, successful completion thereof can be shown in entry 635. Progress can be shown via a progress bar 640.

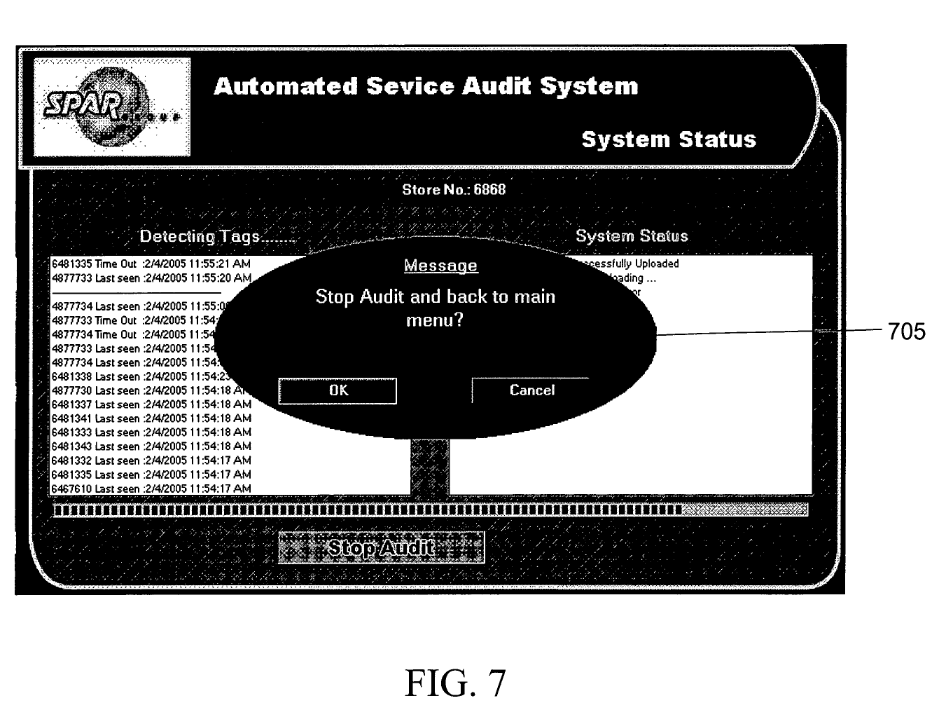

Additionally, the user has the option of stopping the audit 645. If the user selects this option, as shown in FIG. 7 the system displays a message 705 that prompts the user to confirm that the choice is to discontinue the audit and return to, for example, the main menu.

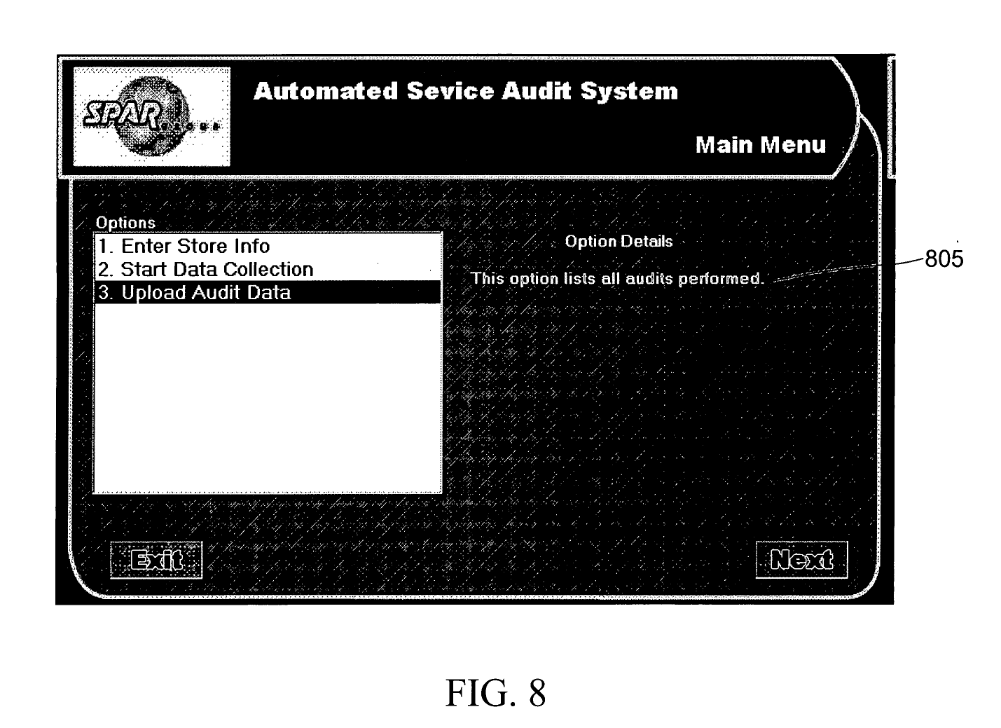

As shown in FIG. 8, if uploading data is selected from the main user interface screen, the application can list all the audits performed 805. Such data can be stored in databases 265 if so desired. The upload may be performed at any time, either initiated by the user or done automatically.

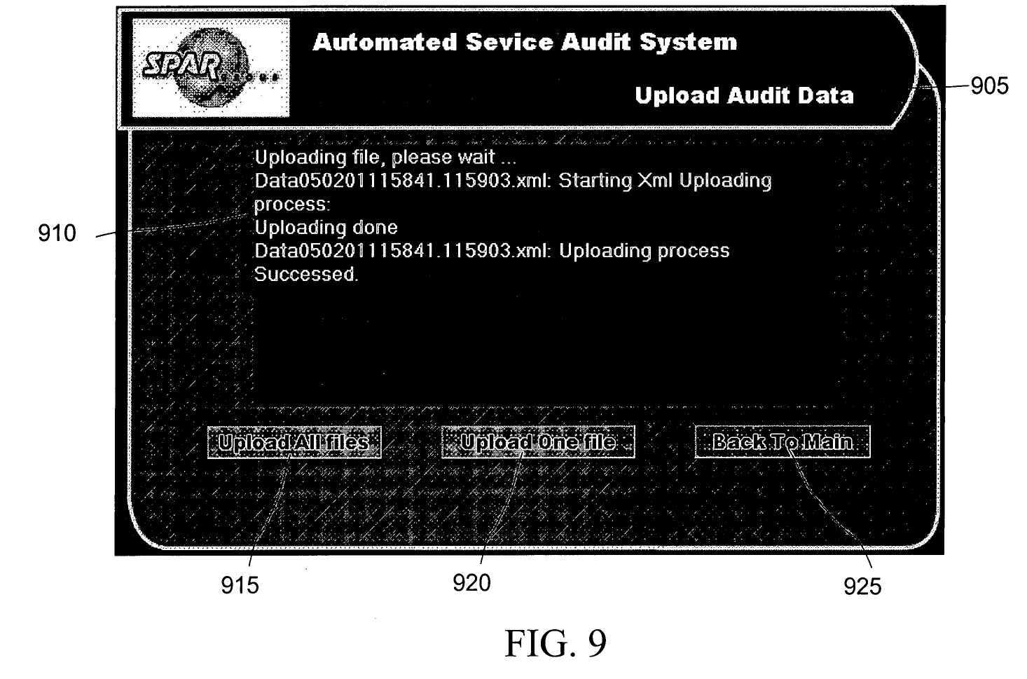

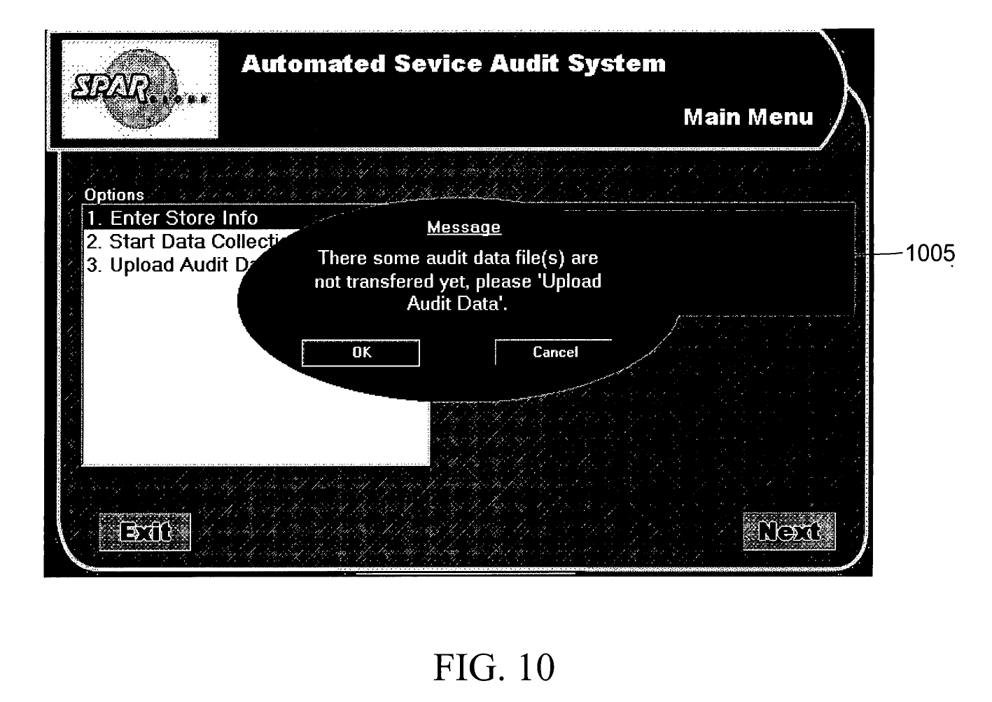

An exemplary user interface screen showing upload audit data is shown in FIG. 9. The specific status can be shown 910. User options include uploading all files 915, uploading one file 920, or going back to the main menu 925. If one or more data files have not yet been transferred, a message indicating such 1005 can be presented to the user, as shown in FIG. 10.

In an alternative aspect of the present invention, RFID tags can be used to keep track of personnel attending a given event, such as a demonstration of a new product or a demonstration of the benefits of RFID technology or training session thereof. One reason for the significance of tracking the attendance at such demonstrations is so that a retailer 260 or manufacturer 255 knows that the sales or service personnel associated with the product indeed attended a given product demonstration to ensure that desired quality assurance is maintained. Another reason, as described above with respect to the merchandising service provider is to confirm that such personnel are in fact entitled to payment for conducting the demonstration. The demonstration may be conducted for independent sales or service personnel, store employees or both.

In accordance with the present invention, the personnel attending the training session wear or otherwise keep near their person a unique RFID tag, such as in an employee badge. Personnel can be issued an RFID tag for the specific purpose of the demonstration, or they may hold the same tag for the duration of their employment. In either case, the tags may be reused later. Further, it is possible to issue tags to customers of the retailer 260 or manufacturer as well for similar purposes.

In the preferred embodiment, a portable RFID reader 110 is used that can be transported throughout a store along with the devices and materials used to conduct the demonstrations (e.g., a video player). Such a reader 110 may be used in connection with demonstrations in multiple sections of the store. For example, a first demonstration can be conducted in one section of the store (e.g., lumber), and subsequently, the reader and other demonstration devices and materials can be transported to an audience in the paint section. These capabilities only serve to highlight the mobility and real-time versatility of the RFID technology of the present invention.

Once the RFID tags on the audience have been read, the data can be uploaded to store management, either locally or remotely situated, or other personnel of the retailer 260 or manufacturer 255. Further, the data can also be sent to a vendor that will then be able to confirm that selected personnel have been duly trained.

The system of the present invention thus provides the option of tracking the demonstration of product information to a variety of individuals. Such demonstration may take the form of multimedia files with slides that can be displayed on a portable device, such as a laptop computer or a DVD player with a video monitor. In the preferred embodiment, the same type of device 120 that is used for data collection in the above embodiment (see FIG. 3) can also be used to present and track product demonstrations. The system of the present invention can also track the total time each audience member of the demonstration using RFID technology.

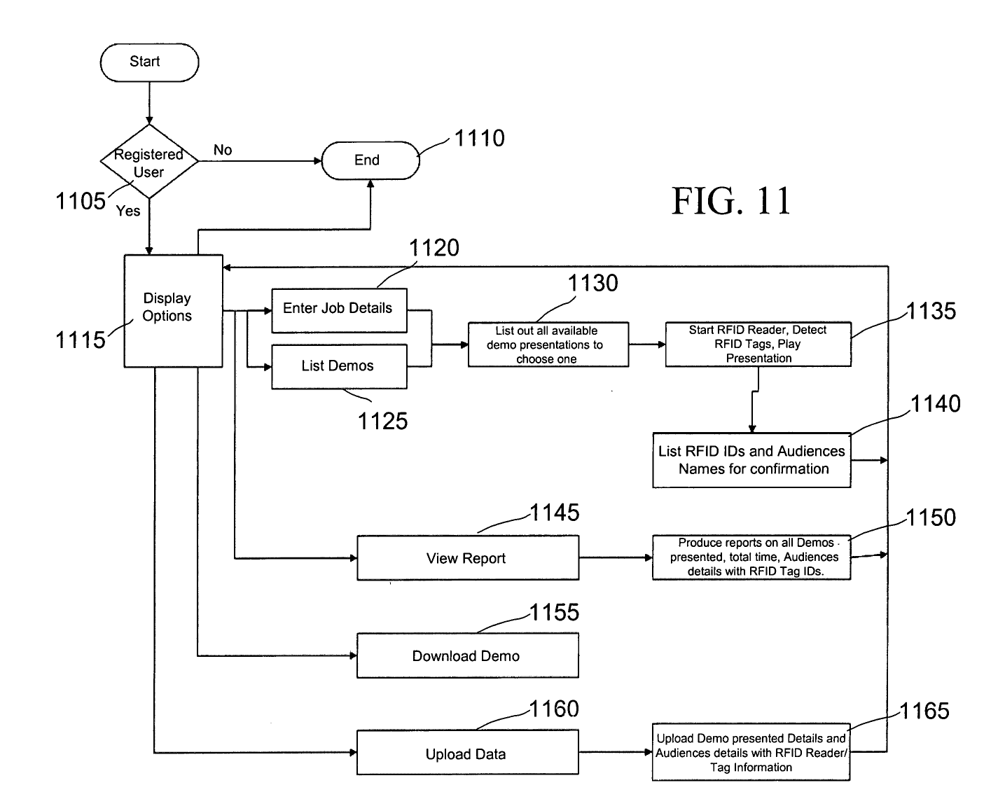

FIG. 11 shows exemplary features of a demonstration utilizing RFID technology. Initially, it must be determined that the user conducting the demonstration using the present invention is registered 1105. If not, the application is terminated 1110. If the user is registered, options are displayed 1115. One option is to enter job details 1120 such as the store number and the client (manufacturer, retailer). Optionally, the types of demonstrations 1125 can be listed. If either option 1120 or 1125 is selected, available demonstrations can be presented for user choice 1130. Once a demonstration is chosen, an RFID reader 110 can be started, tags 100 of the audience detected, and the presentation (demonstration) played 1135. A list of the RFID ids and names of the respective individuals with the tags can be displayed for confirmation 1140. At this point, options can again be displayed 1115.

Alternatively, after options are displayed, reports can be viewed 1145. If this is selected, reports can be produced on all demonstrations presented, the total time thereof, and details on the audience provided including RFID tags 1150. As another option, one can download a demonstration 1155 to the remote device 120, from the central server 251. Yet another option is to upload collected data 1160. Such data uploaded can include the demonstration presented along with details on the audience, again with RFID reader and tag information 1165. It will be appreciated that information can be downloaded from, as well as uploaded to, merchandising service provider 250.

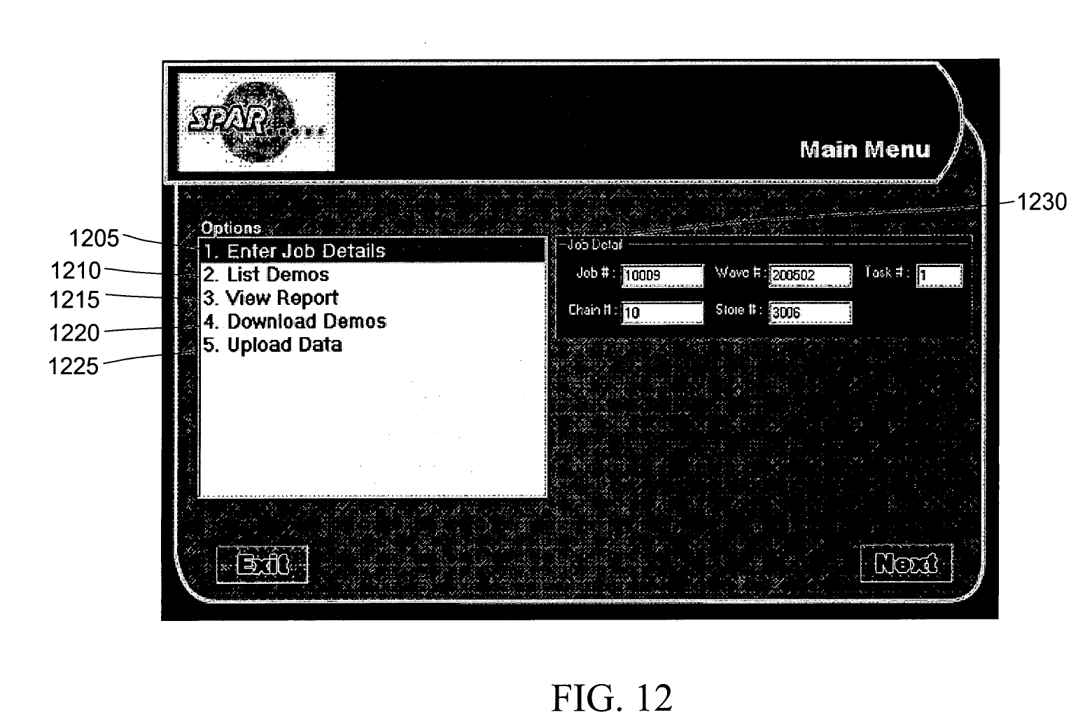

FIG. 12 shows a main user interface that can be used in conjunction with implementing a demonstration. Options 1205 presented to the user can include entering job details 1205, listing demos 1210, viewing reports on demos performed 1215, downloading demos 1220, and upload data 1225. In the interface illustrated in FIG. 12, the user has selected to enter job details and input area 1230 is displayed to the user to enter such details.

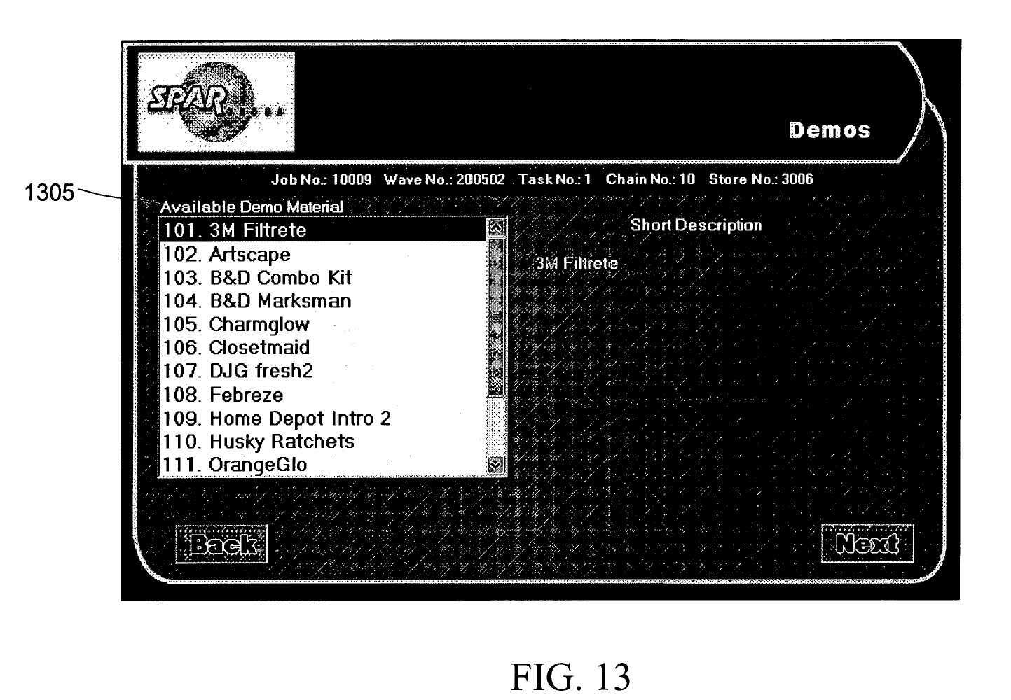

If the user selects List Demos 1210, the demos may be listed for user selection, as shown in FIG. 13. This user interface displays to the user, all of the demonstrations 1305 that are currently loaded on the demonstration workstation. Optionally, the system can display to the user the demonstrations that are available for downloading to the workstation.

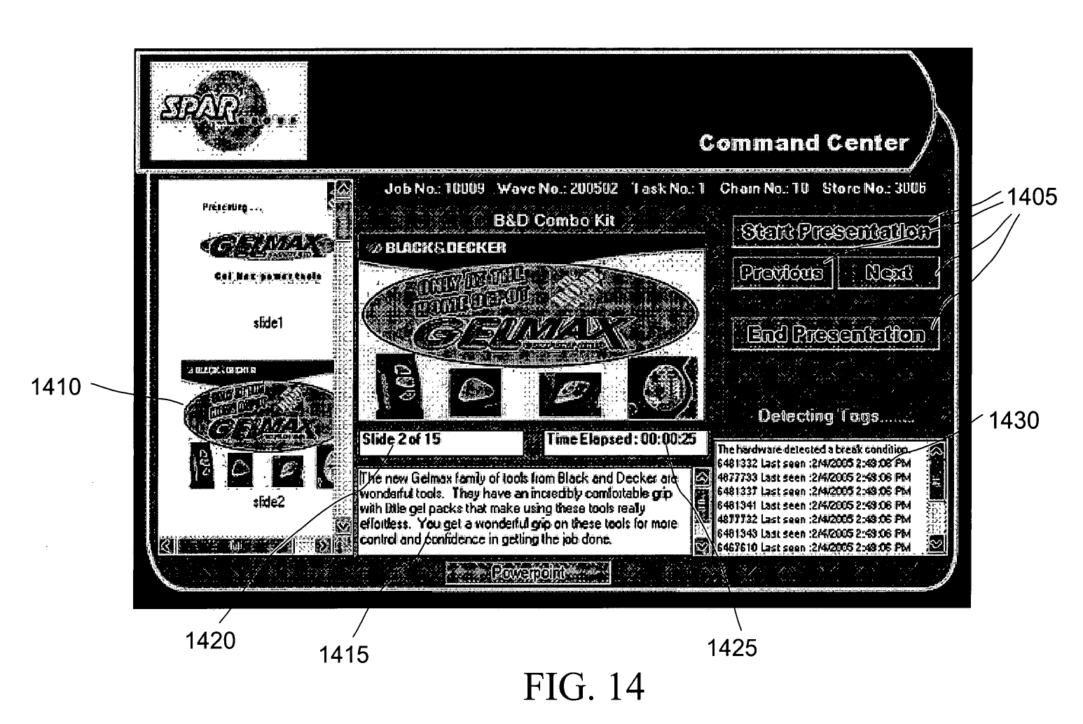

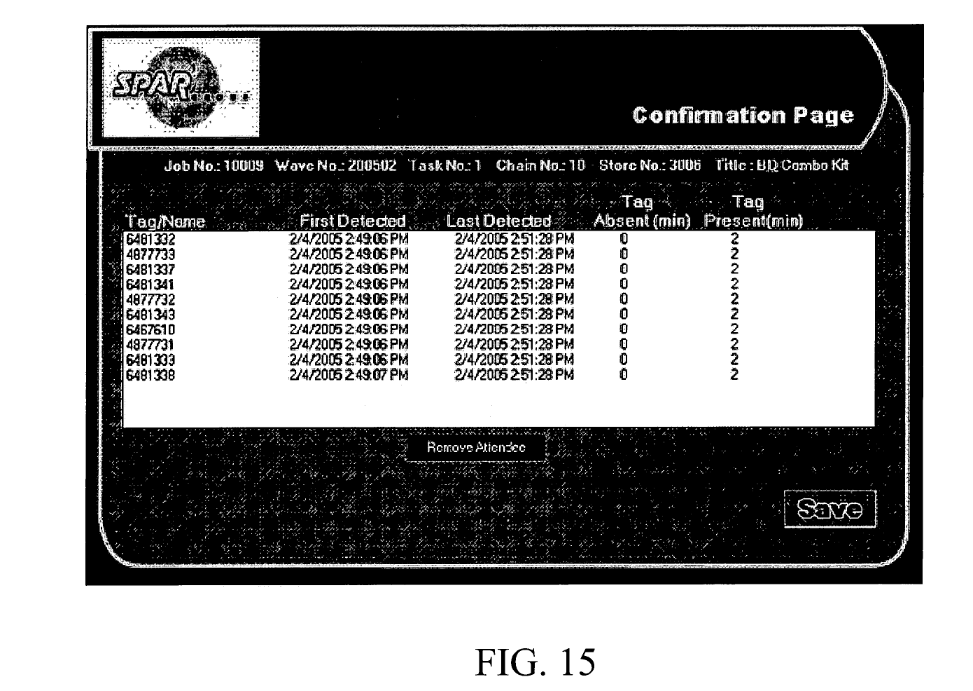

When actually conducting a demonstration on the workstation, a Command Center screen like that shown in FIG. 14 allows the user to select a presentation either by selecting buttons 1405 or clicking on an image in a pane 1410. It also can show notes associated with a slide 1415, slide number 1420, time elapsed 1425, and tags detected 1430. In addition, a confirmation page as shown in FIG. 15 can confirm the details relating to the audience including detected RFID tags.

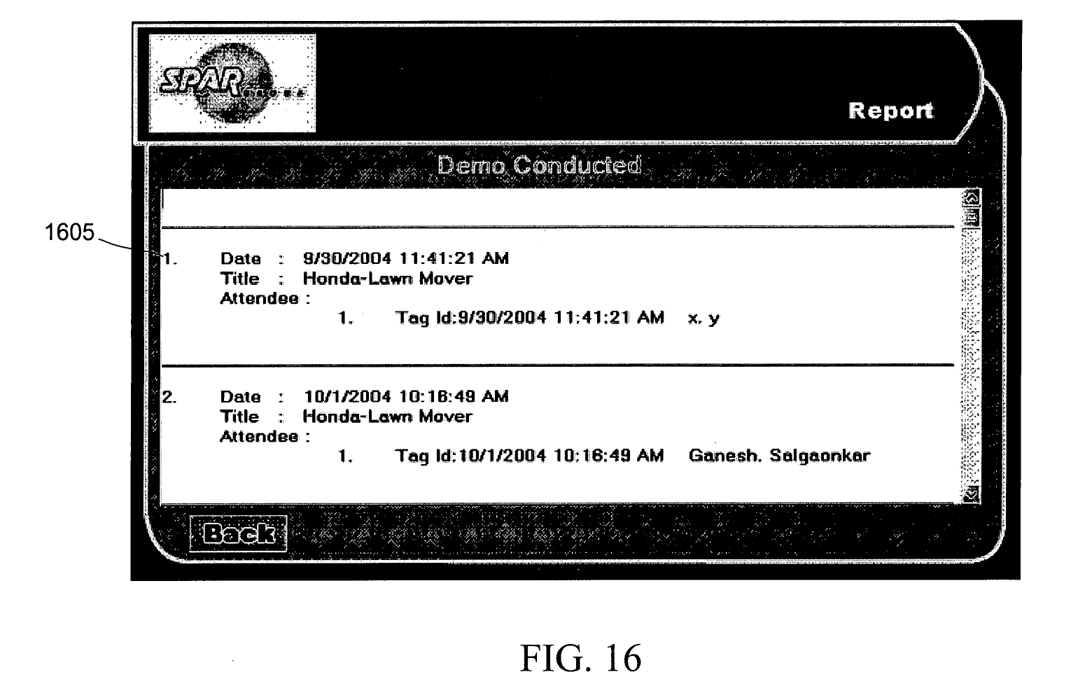

Returning to FIG. 12, if option 3 is selected, the user is able to view a report on the demonstrations performed 1215. An exemplary report can be seen in FIG. 16, including data collected 1605 that is associated with the demonstration.

If option 4 is selected from the main user interface illustrated in FIG. 12, a demonstration can be downloaded 1220 at the direction of the merchandising service provider. If option 5 is selected, data can be uploaded 1225 at the direction of the merchandising service provider.

It can also be appreciated that the merchandising service provider can perform many types of information processing techniques on the data gathered. The merchandising service provider 250 can perform data mining, to attempt to find patterns in consumer behavior.

An additional aspect of the present invention is that the data and reports collected and generated by the merchandising service provider can be hosted on a secure website of the merchandising service provider. The clients thus have easy and uniform access to all of the data and reports provided by the merchandising service provider.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed as new and desired to be protected by Letters Patent of the United States is:

1. A method of tracking an activity of a merchandising servicers at a retail location, the method comprising:
providing the merchandising service provider with a Radio Frequency Identification (RFID) tag that uniquely identifies the merchandising servicers;
detecting the presence or absence of the merchandising servicers's RFID tag at the retail location at which the merchandising servicers is to perform the activities;
transmitting results of the detection to a central location, the results including at least an identification of the merchandising servicers from the RFID tag and time stamp associated with the detection; and
storing the results in a tracking database.

2. The method according to claim 1, wherein the activity comprises performing merchandising services.

3. The method according to claim 1, wherein the detecting and transmitting steps occur substantially in real time

4. The method according to claim 1, wherein the activity comprises engaging in the training of a product or service.

5. The method according to claim 1, further comprising:
accessing the tracking database;
generating a report that includes information on the location of the merchandising service provider at specific times; and
transmitting the report to an entity that ordered the activity of the merchandising servicers.

6. A method of tracking a demonstration of goods or services by use of Radio Frequency Identification (RFID) technology, the method comprising:
providing audience members of the demonstration provider with a Radio Frequency Identification (RFID) tag that uniquely identifies each audience member;
detecting the presence or absence of the respective audience members at the demonstration, the detection resulting in demonstration information including at least the identification of the audience members and time stamps associated with the detection;
transmitting the demonstration information to a central location; and
storing the demonstration information in a demonstration database.

7. The method of claim 6, wherein the demonstration is conducted at a location remote from the central location, the method further comprising downloading audio visual materials for use in the demonstration from the demonstration database to a workstation at the remote location.

8. The method according to claim 6, further comprising:
accessing the demonstration database;
generating a report that includes the demonstration information; and
transmitting the report to an entity that ordered the demonstration.

9. The method of claim 6, further comprising:
providing a mobile workstation for conducting the demonstration; and
conducting a plurality of demonstrations at various locations in a retail store.

10. A system for tracking an activity of a merchandising service provider at a retail location, the system comprising:
a Radio Frequency Identification (RFID) tag that uniquely identifies the merchandising service provider;
at least one RFID reader at the retail location detecting the presence or absence of the merchandising service provider's RFID tag in the retail location;
a data collection device receiving the results of the detection and transmitting the results to a central location, the results including at least an identification of the merchandising service provider from the RFID tag and time stamp associated with the detection;
a central server at a central location receiving the transmitted results; and
a tracking database coupled to the central server, the results being stored in the tracking database.

11. The system of claim 10, further comprising:
a first connection between the at least one RFID reader and the data collection device; and
a second connection between the data collection device and the central server.

12. The system of claim 11, wherein the connection between the at least one RFID reader and the data collection device is wireless and wherein the connection between the data collection device and the central server is over the Internet.

13. The system of claim 11, wherein the data collection device and the at least one RFID reader are incorporated into a single unit.

14. The system of claim 11, wherein the at least one RFID reader is handheld.

15. The system of claim 11, wherein the at least one RFID reader is incorporated into a shelf in the retail location.

16. A system for tracking a demonstration of goods or services by use of Radio Frequency Identification (RFID) technology, the system comprising:
Radio Frequency Identification (RFID) tags that uniquely identify each audience member of the demonstration;
an RFID reader that detects the presence or absence of the respective audience members at the demonstration, the detection resulting in demonstration information including at least the identification of the audience members and time stamps associated with the detection;
a data collection device receiving the demonstration information from the RFID reader and transmitting the demonstration information to a central location; and
a central server at a central location receiving the demonstration information from the data collection device; and
a demonstration database coupled to the central server, the demonstration information being stored in the demonstration database.

17. A product purchase and sales tracking system comprising:
a Radio Frequency Identification (RFID) tag, the RFID tag being placed on a product to be tracked, the RFID tag transmitting product information related to the product;
an RFID reader located in proximity to the point of purchase of the product, the RFID reader detecting the purchase of the product from the point of purchase and generating detection information, the detection information including the product information and a time stamp relative to the time of the purchase;
a data collection device coupled to the RFID reader and receiving the detection information and transmitting the detection information to a central location;
at least one tracking server at the central location, the at least one tracking server programmed to identify substantially in real time the purchase of the product.

18. The system of claim 17, further comprising:
a second RFID reader located in proximity to the point of sale of the product, the second RFID reader detecting the sale of the product and generating sales information, the sales information including the product information and a second time stamp relative to the time of the sale, wherein the second RFID reader is coupled to the data collection device which transmits the sales information to the central location.

19. The system of claim 17, further comprising a second RFID tag placed on a promotional fixture, wherein the RFID reader detects a location of the promotional fixture.

20. The system of claim 17, further comprising:
at least one database coupled to the at least one tracking server, the at least one database storing the detection information.
